(19) United States
(12) Patent Application Publication
(10) Pub. No.: US 2017/0268612 A1
(43) Pub. Date: Sep. 21, 2017

(54) PLANETARY GEAR TRAIN OF AUTOMATIC TRANSMISSION FOR VEHICLES

(71) Applicant: Hyundai Motor Company, Seoul (KR)

(72) Inventors: Wonmin Cho, Hwaseong (KR); Seong Wook Hwang, Gunpo (KR); Hyun Sik Kwon, Seoul (KR); Jae Chang Kook, Hwaseong (KR); Seongwook JI, Gunpo (KR)

(21) Appl. No.: 15/257,346

(22) Filed: Sep. 6, 2016

(30) Foreign Application Priority Data
Mar. 16, 2016 (KR) 10-2016-0031668

(51) Int. Cl. F16H 3/66

(52) U.S. Cl. CPC F16H 3/66; F16H 2200/0065; F16H 2200/2012; F16H 2200/2046

(57) ABSTRACT

A planetary gear train of an automatic transmission for a vehicle is provided. The planetary gear train includes an input shaft that receives power of an engine and an output shaft that outputs the power. Additionally, four planetary gear sets are provided, each including three rotational elements. Various shafts then either directly or selectively connect the rotational elements. The planetary gear train maximizes driving efficiency of the engine and improves power delivery performance and fuel consumption through the achievement of the increased shift-stages of the automatic transmission.

### CROSS-REFERENCE TO RELATED APPLICATION

This application claims priority to and the benefit of Korean Patent Application No. 10-2016-0031668 filed in the Korean Intellectual Property Office on Mar. 16, 2016, the entire contents of which are incorporated herein by reference.

### BACKGROUND

(a) Field of the Invention

The present invention relates to an automatic transmission for a vehicle, and more particularly, to a planetary gear train of an automatic transmission for a vehicle capable of obtaining a power delivery performance improving effect and fuel consumption improving effect by implementing at least advance 9-speed shift-stages by a minimal number of components and capable of reducing driving noise of the vehicle by using a driving point in a low revolution per minute (RPM) region of an engine.

(b) Description of the Related Art

In general, in an automatic transmission field, research has been conducted for achievement of more shift-stages to maximize enhancement of fuel consumption and drivability of a vehicle, and recently, increase of oil price is triggering a competition in enhancing fuel consumption of a vehicle. In particular, research has been conducted for an engine to achieve weight reduction and to enhance fuel consumption by downsizing and research has been conducted for an automatic transmission to simultaneously provide better drivability and fuel consumption by achieving more shift-stages.

However, for the automatic transmission, as the number of shift stages is increased, the number of internal parts, particularly, the number of planetary gear sets also increases and a full length of the transmission is increased, thereby causing mountability, production cost, weight, power transfer efficiency, etc., to be deteriorated. Therefore, it may be important for the automatic transmission to develop a planetary gear train capable of generating maximum efficiency with a minimal number of parts to increase a fuel consumption improvement effect through the achievement of the more shift-stages.

Recently, the automatic transmission has been configured to implement a shift of 8-speed or more and has been installed within the vehicle, and research and development for a planetary gear train capable of implementing shift-stages of 8-speed or more have been actively demanded. However, a general automatic transmission of 8-speed or more generally includes 3 to 4 planetary gear sets and 5 to 6 control elements (friction elements), and since the full length of the transmission is increased, there is a disadvantage that mountability deteriorates.

Therefore, to achieve the more shift-stages of the automatic transmission, recently, a double row structure in which the planetary gear set is disposed on the planetary gear set has been adopted, or a dog clutch has been applied instead of a wet control element. However, such an applicable structure is limited, and deterioration of shift sense is accompanied due to the application of the dog clutch.

The above information disclosed in this section is merely for enhancement of understanding of the background of the invention and therefore it may contain information that does not form the prior art that is already known in this country to a person of ordinary skill in the art.

### SUMMARY

The present invention provides a planetary gear train of an automatic transmission for a vehicle capable of obtaining power delivery performance improvement and fuel consumption improving effect through achievement of more shift-stages by implementing at least advance 9-speed shift-stages or more and at least a reverse 1-speed shift-stage or more by a minimal number of components and capable of reducing driving noise of the vehicle by using a driving point in a low revolution per minute (RPM) region of an engine.

An exemplary embodiment of the present invention provides a planetary gear train of an automatic transmission for a vehicle that may include: an input shaft configured to receive power of an engine; an output shaft configured to output the power; a first planetary gear set having first, second, and third rotation elements; a second planetary gear set having fourth, fifth, and sixth rotation elements; a third planetary gear set having seventh, eighth, and ninth rotation elements; a fourth planetary gear set having tenth, eleventh, and twelfth rotation elements; a first shaft connected to the first rotation element; a second shaft that connects the second rotation element, and the sixth rotation element and the seventh rotation element to each other; a third shaft that connects the third rotation element and the fifth rotation element to each other; a fourth shaft connected to the fourth rotation element and directly connected to the input shaft; a fifth shaft that connects the eighth rotation element and the twelfth rotation element to each other, and selectively connected to the fourth shaft or selectively connected to a transmission housing; a sixth shaft that connects the ninth rotation element and the eleventh rotation element to each other and directly connected to the output shaft; and a seventh shaft connected to the tenth rotation element and selectively connected to the fourth shaft. Each of the first shaft, the second shaft, and the third shaft may be selectively connected to the transmission housing.

The first, second, and third rotation elements of the first planetary gear set may be a first sun gear, a first planetary carrier, and a first ring gear, respectively, the fourth, fifth, and sixth rotation elements of the second planetary gear set may be a second sun gear, a second planetary carrier, and a second ring gear, respectively, the seventh, eighth, and ninth rotation elements of the third planetary gear set may be a third sun gear, a third planetary carrier, and a third ring gear, respectively, and, the tenth, eleventh, and twelfth rotation elements of the fourth planetary gear set may be a fourth sun gear, a fourth planetary carrier, and a fourth ring gear, respectively.

The planetary gear train may further include: a first clutch that selectively connects the fourth shaft and the fifth shaft to each other; a second clutch that selectively connects the fourth shaft and the seventh shaft to each other; a first brake that selectively connects the first shaft and the transmission housing to each other; a second brake that selectively connects the second shaft and the transmission housing to each other; a third brake that selectively connects the third shaft and the transmission housing to each other; and a fourth brake that selectively connects the fifth shaft and the transmission housing to each other. According to an exemplary embodiment of the present invention, the shift stage of at least advance 9-speed or more and the shift state of at least reverse 1-speed or more may be implemented by combining four planetary gear sets formed of simple planetary gear sets with six control elements.

Further, according to an exemplary embodiment of the present invention, the shift-stage suitable for the revolution per minute of the engine may be implemented by achieving the more shift-stages of the automatic transmission, and particularly, driving noise of the vehicle may be reduced by using the driving point in the low revolution per minute region of the engine. Additionally, according to an exemplary embodiment of the present invention, driving efficiency of the engine may be maximized, and power delivery performance and fuel consumption may be improved through the high efficient achievement of the more shift-stages of the automatic transmission.

Other effects that may be obtained or predicted from the exemplary embodiments of the present invention will be explicitly or implicitly disclosed in the detailed description of the exemplary embodiments of the present invention. That is, various effects predicted according to the exemplary embodiments of the present invention will be disclosed in the detailed description to be described below.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a configuration diagram of a planetary gear train according to an exemplary embodiment of the present invention; and

FIG. 2 is an operation table for each shift stage of a control element which is used for the planetary gear train according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

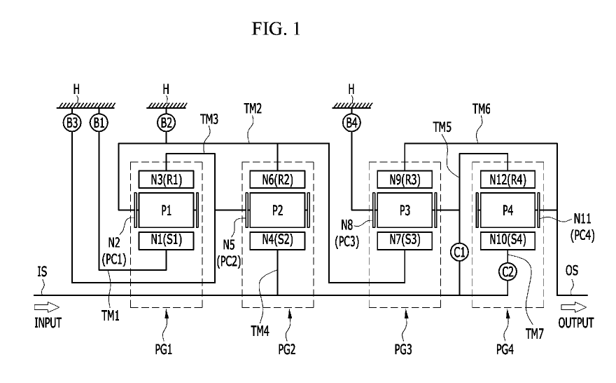

FIG. 1 is a configuration diagram of a planetary gear train according to an exemplary embodiment of the present invention. Referring to FIG. 1, the planetary gear train according to an exemplary embodiment of the present invention may include first, second, third, and fourth planetary gear sets PG1, PG2, PG3, and PG4 disposed on the same axis, an input shaft IS, an output shaft OS, seven shafts TM1 to TM7 that connect the respective rotation elements of the first, second, third, and fourth planetary gear sets PG1, PG2, PG3, and PG4 to each other, two clutches C1 and C2, and four brakes B1 to B4, which are control elements, and a transmission housing H.

In addition, rotation power from an engine input from the input shaft IS may be shifted by a mutual complementing operation between the first, second, third, and fourth planetary gear sets PG1, PG2, PG3, and PG4 and may then be output through the output shaft OS. Particularly, the respective planetary gear sets may be disposed in a sequence of the first, second, third, and fourth planetary gear sets PG1, PG2, PG3, and PG4 from an engine side. The input shaft IS may be an input member, and rotation power from a crack shaft of the engine may be input to the input shaft after a torque thereof is converted using a torque converter. The output shaft OS, which is an output member, may be disposed on the same axis as an axis on which the input shaft IS is disposed and may be configured to transfer shifted driving force to a driving shaft using a differential apparatus.

The first planetary gear set PG1, which is a single pinion planetary gear set, may include a first sun gear S1, which is a first rotation element N1, a first planetary carrier PC1, which is a second rotation element N2, configured to rotationally support a first pinion gear P1 externally engaged with the first sun gear S1, which is the first rotation element N1, and a first ring gear R1, which is a third rotation element N3, internally engaged with the first pinion gear P1. The second planetary gear set PG2, which is a single pinion planetary gear set, may include a second sun gear S2 which is a fourth rotation element N4, a second planetary carrier PC2 which is a fifth rotation element N5 configured to rotationally support a second pinion gear P2 externally engaged with the second sun gear S2 which is the fourth rotation element N4, and a second ring gear R2 which is a sixth rotation element N6 internally engaged with the second pinion gear P2.

The third planetary gear set PG3, which is a single pinion planetary gear set, may include a third sun gear S3, which is a seventh rotation element N7, a third planetary carrier PC3, which is an eighth rotation element N8, configured to rotationally support a third pinion gear P3 externally engaged with the third sun gear S3, which is the seventh rotation element N7, and a third ring gear R3, which is a ninth rotation element N9, internally engaged with the third pinion gear P3. The fourth planetary gear set PG4, which is a single pinion planetary gear set, may include a fourth sun gear S4, which is a tenth rotation element N10, a fourth planetary carrier PC4, which is an eleventh rotation element N11, configured to rotationally support a fourth pinion gear P4 externally engaged with the fourth sun gear S4, which is the tenth rotation element N10, and a fourth ring gear R4, which is a twelfth rotation element N12, internally engaged with the fourth pinion gear P4.

Particularly, in the first, second, third, and fourth planetary gear sets PG1, PG2, PG3, and PG4, the second rotation element N2 may be directly connected to the sixth rotation element N6 and the seventh rotation element N7, the third rotation element N3 may be directly connected to the fifth rotation element N5, the eighth rotation element N8 may be directly connected to the twelfth rotation element N12, and the ninth rotation element N9 may be directly connected to the eleventh rotation element N11, and thus, the first, second, third, and fourth planetary gear sets PG1, PG2, PG3, and PG4 may be operated while having a total of seven shafts TM1 to TM7. Configurations of the seven shafts TM1 to TM7 will be described in detail below.

The seven shafts TM1 to TM7 may be rotation members configured to transfer power while being rotated together with the rotation elements connected to directly connect or selectively connect a plurality of rotation elements, among the rotation elements of the planetary gear sets PG1, PG2, PG3, and PG4, and may be fixed members directly connecting the rotation element to the transmission housing H to fix the rotation element to the transmission housing H.

The first shaft TM1 may be connected to the first rotation element N1 (the first sun gear S1), and may be operated as a selective fixed element while being selectively connected to the transmission housing H. The second shaft TM2 may connect the second rotation element N2 (the first planetary carrier PC1) and the sixth rotation element N6 (the second ring gear R2) to the seventh rotation element N7 (the third sun gear S3), and may be operated as a selective fixed element while being selectively connected to the transmission housing H. The third shaft TM3 may connect the third rotation element N3 (the first ring gear R1) and the fifth rotation element N5 (the second planetary carrier PC2), and may be operated as a selective fixed element while being selectively connected to the transmission housing H. The fourth shaft TM4 may be connected to the fourth rotation element N4 (the second sun gear S2), and may be directly connected to the input shaft IS to be operated as an input element.

The fifth shaft TM5 may connect the eighth rotation element N8 (the third planetary carrier PC3) and the twelfth rotation element N12 (the fourth ring gear R4), and may be operated as a selective input element while being selectively connected to the fourth shaft TM4 directly connected to the input shaft IS, or may be operated as a selective fixed element while being selectively connected to the transmission housing H. The sixth shaft TM6 may connect the ninth rotation element N9 (the third ring gear R3) and the eleventh rotation element N11 (the fourth planetary carrier PC4), and may be directly connected to the output shaft OS to be operated as an output element. The seventh shaft TM7 may be connected to the tenth rotation element N10 (the fourth sun gear S4), and may be selectively connected to the fourth shaft TM4 directly connected to the input shaft IS to be operated as a selective input element.

In addition, the two clutches C1 and C2 may be disposed at portions of shafts including the input shaft IS and the output shaft OS selectively connected to each other among the seven shafts TM1 to TM7. In addition, the four brakes B1 to B4 may be disposed at portions of shafts selectively connected to the transmission housing H among the seven shafts TM1 to TM7. In other words, disposed positions of the two clutches C1 and C2, and the four brakes B1 to B4 will be described below. A first clutch C1 may be disposed between the fourth shaft TM4 and the fifth shaft TM5 to selectively connect the fourth shaft TM4 and the fifth shaft TM5 directly connected to the input shaft IS to transfer power. A second clutch C2 may be disposed between the fourth shaft TM4 and the seventh shaft TM7 to selectively connect the fourth shaft TM4 and the seventh shaft TM7 directly connected to the input shaft IS to transfer power.

A first brake B1 may be disposed between the first shaft TM1 and the transmission housing H to selectively connect the first shaft TM1 to the transmission housing H to be fixed. A second brake B2 may be disposed between the second shaft TM2 and the transmission housing H to selectively connect the second shaft TM2 to the transmission housing H to be fixed. A third brake B3 may be disposed between the third shaft TM3 and the transmission housing H to selectively connect the third shaft TM3 to the transmission housing H to be fixed. A fourth brake B4 may be disposed between the fifth shaft TM5 and the transmission housing H to selectively connect the fifth shaft TM5 to the transmission housing H to be fixed. The respective control elements including the first and second clutches C1 and C2 and the first to fourth brakes B1 to B4 may be formed of multi-plate type hydraulic pressure friction-coupled units friction-coupled to each other by hydraulic pressure.

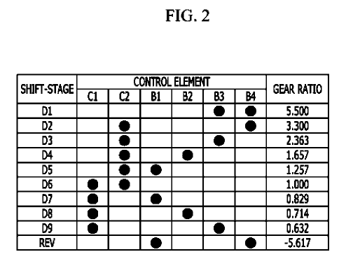

FIG. 2 is an operation table for each shift stage of a control element which is used for the planetary gear train according to an exemplary embodiment of the present invention. Referring to FIG. 2, in each shift stage of the planetary gear train according to an exemplary embodiment of the present invention, while two control elements among the first and second clutches C1 and C2, and the first to fourth brakes B1 to B4, which are the control elements, are operated, shifts of reverse 1-speed and advance 9-speed may be performed. A shift operation will be described below.

In an advance 1-speed shift-stage D1, the third and fourth brakes B3 and B4 may be operated simultaneously with a gear ratio of about 5.5. Therefore, rotation power of the input shaft IS may be input to the fourth shaft TM4, and a shift-stage may be shifted to an advance 1-speed while the third shaft TM3 and the sixth shaft TM6 may be operated simultaneously as the fixed element by the third and fourth brakes B3 and B4, and thus, the rotation power may be output through the output shaft OS connected to the sixth shaft TM6.

In an advance 2-speed shift-stage D2, the second clutch C2 and the fourth brake B4 may be operated simultaneously with a gear ratio of about 3.3. Therefore, the rotation power of the input shaft IS may be input to the fourth shaft TM4 and may be input to the seventh shaft TM7 by an operation of the second clutch C2 at the same time. In addition, the shift-stage may be shifted to an advance 2-speed while the fifth shaft TM5 is operated as the fixed element by the fourth brake B4, and thus, the rotation power may be output through the output shaft OS connected to the sixth shaft TM6.

In an advance 3-speed shift-stage D3, the second clutch C2 and the third brake B3 may be operated simultaneously with a gear ratio of about 2.363. Therefore, the rotation power of the input shaft IS may be input to the fourth shaft TM4 and may be input to the seventh shaft TM7 by an operation of the second clutch C2 at the same time. In addition, the shift-stage may be shifted to an advance 3-speed while the third shaft TM3 is operated as the fixed element by the third brake B3, and thus, the rotation power may be output through the output shaft OS connected to the sixth shaft TM6.

In an advance 4-speed shift-stage D4, the second clutch C2 and the second brake B2 may be operated simultaneously with a gear ratio of about 1.657. Therefore, the rotation power of the input shaft IS may be input to the fourth shaft TM4 and may be input to the seventh shaft TM7 by an operation of the second clutch C2 at the same time. In addition, the shift-stage may be shifted to an advance 4-speed while the second shaft TM2 is operated as the fixed element by the second brake B2, and thus, the rotation power may be output through the output shaft OS connected to the sixth shaft TM6.

In an advance 5-speed shift-stage D5, the second clutch C2 and the first brake B1 may be operated simultaneously with a gear ratio of about 1.257. Therefore, the rotation power of the input shaft IS may be input to the fourth shaft TM4 and may be input to the seventh shaft TM7 by an operation of the second clutch C2 at the same time. In addition, the shift-stage may be shifted to an advance 5-speed while the first shaft TM1 is operated as the fixed element by the first brake B1, and thus, the rotation power may be output through the output shaft OS connected to the sixth shaft TM6.

In an advance 6-speed shift-stage D6, the first and second clutches C1 and C2 may be operated simultaneously with a gear ratio of about 1. Therefore, the rotation power of the input shaft IS may be input to the fourth shaft TM4 and may be input to the fifth and seventh shaft TM5 and TM7 by the operation of the first and second clutches C1 and C2 at the same time. In this case, the shift-stage may be shifted to an advance 6-speed that outputs an input as it is while the fourth planetary gear set PG4 is integrally rotated, and thus, the rotation power may be output through the output shaft OS connected to the sixth shaft TM6.

In an advance 7-speed shift-stage D7, the first clutch C1 and the first brake B1 may be operated simultaneously with a gear ratio of about 0.829. Therefore, the rotation power of the input shaft IS may be input to the fourth shaft TM4 and may be input to the fifth shaft TM5 by an operation of the first clutch C1 at the same time. In addition, the shift-stage may be shifted to an advance 7-speed while the first shaft TM1 is operated as the fixed element by the first brake B1, and thus, the rotation power may be output through the output shaft OS connected to the sixth shaft TM6.

In an advance 8-speed shift-stage D8, the first clutch C1 and the second brake B2 are simultaneously operated. Therefore, the rotation power of the input shaft IS is input to the fourth shaft TM4 and is input to the fifth shaft TM5 by an operation of the first clutch C1 at the same time. In addition, the shift-stage is shifted to an advance 8-speed while the second shaft TM2 is operated as the fixed element by the second brake B2, such that the rotation power is output through the output shaft OS connected to the sixth shaft TM6.

In an advance 9-speed shift-stage D9, the first clutch C1 and the third brake B3 may be operated simultaneously with a gear ratio of about 0.632. Therefore, the rotation power of the input shaft IS may be input to the fourth shaft TM4 and may be input to the fifth shaft TM5 by an operation of the first clutch C1 at the same time. In addition, the shift-stage may be shifted to an advance 9-speed while the third shaft TM3 is operated as the fixed element by the third brake B3, and thus, the rotation power may be output through the output shaft OS connected to the sixth shaft TM6.

In a reverse shift-stage REV, the first and fourth brakes B1 and B4 may be operated simultaneously with a gear ratio of about −5.617. Therefore, the rotation power of the input shaft IS may be input to the fourth shaft TM4, and a shift-stage may be reversely shifted while the first shaft TM1 and the fifth shaft TM5 are simultaneously operated as the fixed element by the first and fourth brakes B1 and B4, and thus, the rotation power may be output through the output shaft OS connected to the sixth shaft TM6.

As described above, the planetary gear train according to an exemplary embodiment of the present invention may realize at least 9-speed shift-stages or more and at least a reverse 1-speed shift-stage or more through the four planetary gear sets PG1, PG2, PG3, and PG4 by adjusting the operation of the two clutches C1 and C2 and the four brakes B1, B2, B3, and B4. Further, the planetary gear train according to an exemplary embodiment of the present invention may implement the shift-stage suitable for the revolution per minute of the engine by achieving the increased shift-stage of the automatic transmission, and may particularly reduce driving noise of the vehicle by using the driving point in the low revolution per minute region of the engine. In addition, the planetary gear train according to an exemplary embodiment of the present invention may maximize driving efficiency of the engine and improve power delivery performance and fuel consumption through the achievement of the increased shift-stages of the automatic transmission.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A planetary gear train of an automatic transmission for a vehicle, comprising:
an input shaft configured to receive power of an engine;
an output shaft configured to output the power;
a first planetary gear set including first, second, and third rotation elements;
a second planetary gear set including fourth, fifth, and sixth rotation elements;
a third planetary gear set including seventh, eighth, and ninth rotation elements;
a fourth planetary gear set including tenth, eleventh, and twelfth rotation elements;
a first shaft connected to the first rotation element;
a second shaft that connects the second rotation element, and the sixth rotation element and the seventh rotation element to each other;
a third shaft that connects the third rotation element and the fifth rotation element to each other;
a fourth shaft connected to the fourth rotation element and directly connected to the input shaft;
a fifth shaft that connects the eighth rotation element and the twelfth rotation element to each other, and is selectively connected to the fourth shaft or selectively connected to a transmission housing;
a sixth shaft that connects the ninth rotation element and the eleventh rotation element to each other and is directly connected to the output shaft; and
a seventh shaft connected to the tenth rotation element and selectively connected to the fourth shaft.

2. The planetary gear train of claim 1, wherein each of the first shaft, the second shaft, and the third shaft is selectively connected to the transmission housing.

3. The planetary gear train of claim 1, wherein:
the first, second, and third rotation elements of the first planetary gear set are a first sun gear, a first planetary carrier, and a first ring gear, respectively,
the fourth, fifth, and sixth rotation elements of the second planetary gear set are a second sun gear, a second planetary carrier, and a second ring gear, respectively,
the seventh, eighth, and ninth rotation elements of the third planetary gear set are a third sun gear, a third planetary carrier, and a third ring gear, respectively, and
the tenth, eleventh, and twelfth rotation elements of the fourth planetary gear set are a fourth sun gear, a fourth planetary carrier, and a fourth ring gear, respectively.

4. The planetary gear train of claim 2, further comprising:
a first clutch that selectively connects the fourth shaft and the fifth shaft to each other;
a second clutch that selectively connects the fourth shaft and the seventh shaft to each other;
a first brake that selectively connects the first shaft and the transmission housing to each other;
a second brake that selectively connects the second shaft and the transmission housing to each other;
a third brake that selectively connects the third shaft and the transmission housing to each other; and
a fourth brake that selectively connects the fifth shaft and the transmission housing to each other.

5. A planetary gear train of an automatic transmission for a vehicle, comprising:
an input shaft configured to receive power of an engine;
an output shaft configured to output the power;
a first planetary gear set including first, second, and third rotation elements;
a second planetary gear set including fourth, fifth, and sixth rotation elements;
a third planetary gear set having seventh, eighth, and ninth rotational elements; and
a fourth planetary gear set having tenth, eleventh, and twelfth rotational elements,
wherein the input shaft is directly connected to the fourth rotation element,
wherein the output shaft is directly connected to the eleventh rotation element,
wherein the second rotation element is directly connected to the sixth rotation element and the seventh rotation element,
wherein the third rotation element is directly connected to the fifth rotation element,
wherein the eighth rotation element is directly connected to the twelfth rotation element, and is selectively connected to the fourth rotation element or is selectively connected to a transmission housing,
wherein the ninth rotation element is directly connected to the eleventh rotation element, and
wherein the tenth rotation element is selectively connected to the fourth rotational element.

6. The planetary gear train of claim 5, wherein each of the first, second, and third rotation elements is selectively connected to the transmission housing.

7. The planetary gear train of claim 5, wherein:
the first, second, and third rotation elements of the first planetary gear set are a first sun gear, a first planetary carrier, and a first ring gear, respectively,
the fourth, fifth, and sixth rotation elements of the second planetary gear set are a second sun gear, a second planetary carrier, and a second ring gear, respectively,
the seventh, eighth, and ninth rotation elements of the third planetary gear set are a third sun gear, a third planetary carrier, and a third ring gear, respectively, and
the tenth, eleventh, and twelfth rotation elements of the fourth planetary gear set are a fourth sun gear, a fourth planetary carrier, and a fourth ring gear, respectively.

8. The planetary gear train of claim 6, further comprising:
a first clutch that selectively connects the fourth rotation element and the eighth rotation element to each other;
a second clutch that selectively connects the fourth rotation element and the tenth rotation element to each other;
a first brake that selectively connects the first rotation element and the transmission housing to each other;
a second brake that selectively connects the second rotation element and the transmission housing to each other;
a third brake that selectively connects the third rotation element and the transmission housing to each other; and
a fourth brake that selectively connects the eighth rotation element and the transmission housing to each other.
